(19) United States
(12) Patent Application Publication
(10) Pub. No.: US 2022/0039167 A1
(43) Pub. Date: Feb. 3, 2022

(54) TECHNIQUES FOR SCHEDULING REQUEST SELECTION IN CONSIDERATION OF CHANNEL COLLISION

(71) Applicant: QUALCOMM Incorporated, San Diego, CA (US)

(72) Inventors: Pranay Sudeep RUNGTA, San Diego, CA (US); Krishna Chaitanya MUKKERA, San Diego, CA (US); Avinash Rey Villarba MANDA, San Diego, CA (US)

(21) Appl. No.: 16/947,471

(22) Filed: Aug. 3, 2020

(51) Int. Cl. H04W 74/08; H04L 5/00; H04W 72/12; H04W 72/04

(52) U.S. Cl. CPC H04W 74/0825; H04W 72/0413; H04W 72/1284; H04L 5/0048

(57) ABSTRACT

Various aspects of the present disclosure generally relate to wireless communication. In some aspects, a user equipment (UE) may identify numbers of symbols of a plurality of physical uplink control channel (PUCCH) resources that collide with a sounding reference signal resource, wherein the plurality of PUCCH resources are associated with transmitting a scheduling request (SR). The UE may determine a plurality of collision values associated with the plurality of PUCCH resources. The UE may transmit the SR on a PUCCH resource, of the plurality of PUCCH resources, that is associated with a collision value of the plurality of collision values.

### FIELD OF THE DISCLOSURE

Aspects of the present disclosure generally relate to wireless communication and to techniques and apparatuses for scheduling request (SR) selection in consideration of channel collision.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: identifying numbers of symbols of a plurality of physical uplink control channel (PUCCH) resources that collide with a sounding reference signal (SRS) resource, wherein the plurality of PUCCH resources are associated with transmitting a scheduling request (SR); determining a plurality of collision values associated with the plurality of PUCCH resources; and transmitting the SR on a PUCCH resource, of the plurality of PUCCH resources, that is associated with a collision value of the plurality of collision values.

In some aspects, the collision value is a lowest collision value of the plurality of collision values.

In some aspects, the plurality of PUCCH resources are included in a single slot.

In some aspects, the PUCCH resource includes no symbols that collide with the SRS resource.

In some aspects, the PUCCH resource is associated with one or more symbols that collide with the SRS resource, and the method further comprises transmitting an SRS on the SRS resource, wherein zero or more symbols of the SRS are dropped based at least in part on whether the SRS resource collides with the PUCCH resource.

In some aspects, identifying the numbers of symbols of the plurality of PUCCH resources comprises: determining, for each symbol of a given PUCCH resource, whether each symbol collides with any symbol of the SRS resource; and identifying the number of symbols of the given PUCCH resource that collide with the SRS resource based at least in part on whether each symbol collides with any symbol of the SRS resource; and determining the plurality of collision values comprises determining a collision value, of the plurality of respective values, for the given PUCCH resource in accordance with the number of symbols.

In some aspects, the plurality of collision values are based at least in part on a binary indicator, wherein a first value of the binary indicator indicates that no symbols of a given PUCCH resource collide with the SRS resource, and a second value of the binary indicator indicates that one or more symbols of the given PUCCH resource collide with the SRS resource.

In some aspects, a UE for wireless communication includes: a memory; and one or more processors operatively coupled to the memory, the memory and the one or more processors configured to: identify numbers of symbols of a plurality of PUCCH resources that collide with an SRS resource, wherein the plurality of PUCCH resources are associated with transmitting an SR; determine a plurality of collision values associated with the plurality of PUCCH resources; and transmit the SR on a PUCCH resource, of the plurality of PUCCH resources, that is associated with a collision value of the plurality of collision values.

In some aspects, the collision value is a lowest collision value of the plurality of collision values.

In some aspects, the plurality of PUCCH resources are included in a single slot.

In some aspects, the PUCCH resource includes no symbols that collide with the SRS resource.

In some aspects, the PUCCH resource is associated with one or more symbols that collide with the SRS resource, and the one or more processors are further configured to transmit an SRS on the SRS resource, wherein zero or more symbols of the SRS are dropped based at least in part on whether the SRS resource collides with the PUCCH resource.

In some aspects, the one or more processors, when identifying the numbers of symbols of the plurality of PUCCH resources, are further configured to: determine, for each symbol of a given PUCCH resource, whether each symbol collides with any symbol of the SRS resource; and identify the number of symbols of the given PUCCH resource that collide with the SRS resource based at least in part on whether each symbol collides with any symbol of the SRS resource; and the one or more processors, when determining the plurality of collision values, are further configured to determine a collision value, of the plurality of respective values, for the given PUCCH resource in accordance with the number of symbols.

In some aspects, the plurality of collision values are based at least in part on a binary indicator, wherein a first value of the binary indicator indicates that no symbols of a given PUCCH resource collide with the SRS resource, and a second value of the binary indicator indicates that one or more symbols of the given PUCCH resource collide with the SRS resource.

In some aspects, a non-transitory computer-readable medium storing one or more instructions for wireless communication includes: one or more instructions that, when executed by one or more processors of a UE, cause the one or more processors to: identify numbers of symbols of a plurality of PUCCH resources that collide with an SRS resource, wherein the plurality of PUCCH resources are associated with transmitting an SR; determine a plurality of collision values associated with the plurality of PUCCH resources; and transmit the SR on a PUCCH resource, of the plurality of PUCCH resources, that is associated with a collision value of the plurality of collision values.

In some aspects, the collision value is a lowest collision value of the plurality of collision values.

In some aspects, the plurality of PUCCH resources are included in a single slot.

In some aspects, the PUCCH resource includes no symbols that collide with the SRS resource.

In some aspects, the PUCCH resource is associated with one or more symbols that collide with the SRS resource, and the one or more instructions, when executed by the one or more processors, cause the one or more processors to transmit an SRS on the SRS resource, wherein zero or more symbols of the SRS are dropped based at least in part on whether the SRS resource collides with the PUCCH resource.

In some aspects, the one or more instructions, that cause the one or more processors to identify the numbers of symbols of the plurality of PUCCH resources, cause the one or more processors to: determine, for each symbol of a given PUCCH resource, whether each symbol collides with any symbol of the SRS resource; and identify the number of symbols of the given PUCCH resource that collide with the SRS resource based at least in part on whether each symbol collides with any symbol of the SRS resource; and the one or more instructions, that cause the one or more processors to determine the plurality of collision values, cause the one or more processors to determine a collision value, of the plurality of respective values, for the given PUCCH resource in accordance with the number of symbols.

In some aspects, the plurality of collision values are based at least in part on a binary indicator, wherein a first value of the binary indicator indicates that no symbols of a given PUCCH resource collide with the SRS resource, and a second value of the binary indicator indicates that one or more symbols of the given PUCCH resource collide with the SRS resource.

In some aspects, an apparatus for wireless communication includes: means for identifying numbers of symbols of a plurality of PUCCH resources that collide with an SRS resource, wherein the plurality of PUCCH resources are associated with transmitting an SR; means for determining a plurality of collision values associated with the plurality of PUCCH resources; and means for transmitting the SR on a PUCCH resource, of the plurality of PUCCH resources, that is associated with a collision value of the plurality of collision values.

In some aspects, the collision value is a lowest collision value of the plurality of collision values.

In some aspects, the plurality of PUCCH resources are included in a single slot.

In some aspects, the PUCCH resource includes no symbols that collide with the SRS resource.

In some aspects, the PUCCH resource is associated with one or more symbols that collide with the SRS resource, and the apparatus further comprises means for transmitting an SRS on the SRS resource, wherein zero or more symbols of the SRS are dropped based at least in part on whether the SRS resource collides with the PUCCH resource.

In some aspects, the means for identifying the numbers of symbols of the plurality of PUCCH resources comprises: means for determining, for each symbol of a given PUCCH resource, whether each symbol collides with any symbol of the SRS resource; and means for identifying the number of symbols of the given PUCCH resource that collide with the SRS resource based at least in part on whether each symbol collides with any symbol of the SRS resource; and the means for determining the plurality of collision values comprises means for determining a collision value, of the plurality of respective values, for the given PUCCH resource in accordance with the number of symbols.

In some aspects, the plurality of collision values are based at least in part on a binary indicator, wherein a first value of the binary indicator indicates that no symbols of a given PUCCH resource collide with the SRS resource, and a second value of the binary indicator indicates that one or more symbols of the given PUCCH resource collide with the SRS resource.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of SR selection in consideration of a channel collision, in accordance with various aspects of the present disclosure.

FIG. 4 is a diagram illustrating an example of signaling associated with SR selection in consideration of a channel collision, in accordance with various aspects of the present disclosure.

FIG. 5 is a diagram illustrating an example process associated with SR selection in consideration of a channel collision, in accordance with various aspects of the present disclosure.

FIGS. 6-7 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technologies (RAT), aspects of the present disclosure can be applied to other RATs, such as a 3G RAT, a 4G RAT, and/or a RAT subsequent to 5G (e.g., 6G).

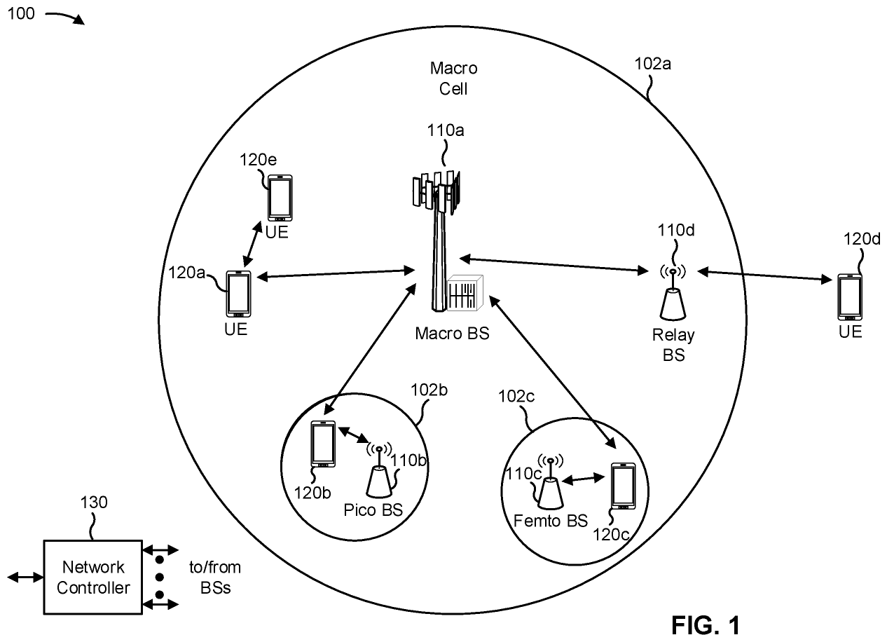

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

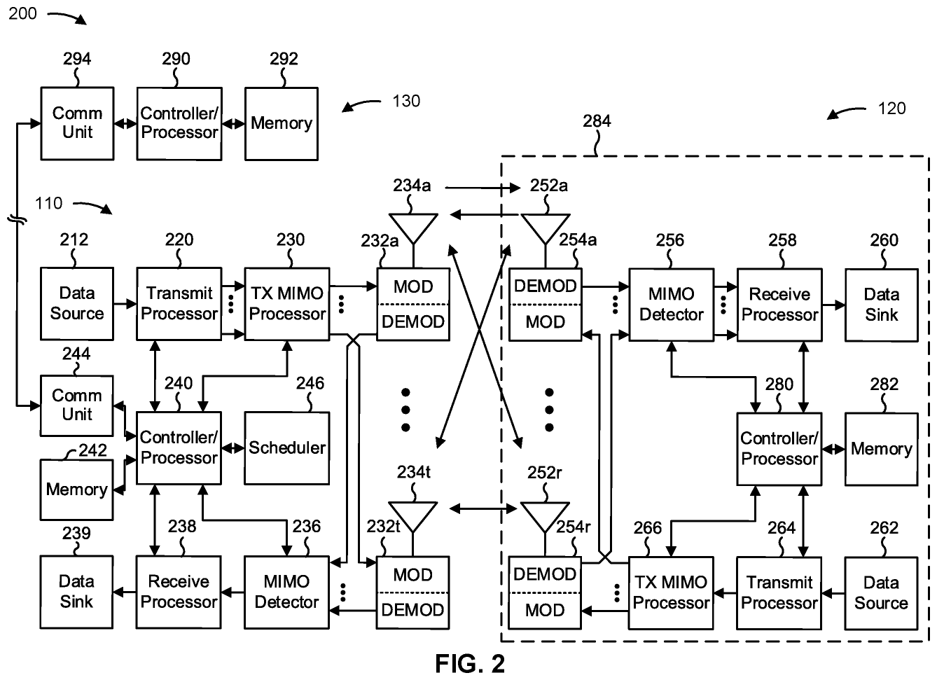

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

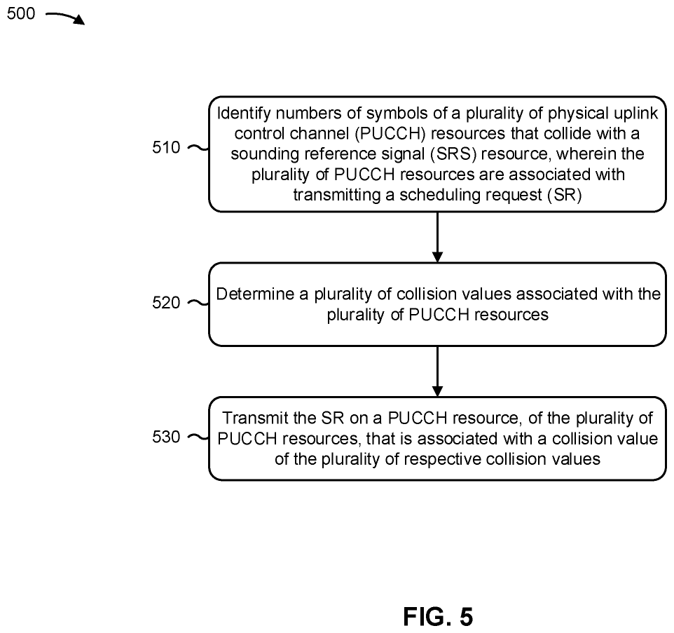

Controller/processor 240 of base station 110, controller/processor 280 of UE 120, and/or any other component(s) of FIG. 2 may perform one or more techniques associated with scheduling request (SR) selection in consideration of channel collision, as described in more detail elsewhere herein. For example, controller/processor 240 of base station 110, controller/processor 280 of UE 120, and/or any other component(s) of FIG. 2 may perform or direct operations of, for example, process 500 of FIG. 5 and/or other processes as described herein. Memories 242 and 282 may store data and program codes for base station 110 and UE 120, respectively. In some aspects, memory 242 and/or memory 282 may include a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 500 of FIG. 5 and/or other processes as described herein. In some aspects, executing instructions may include running the instructions, converting the instructions, compiling the instructions, interpreting the instructions, and/or the like.

In some aspects, UE 120 may include means for identifying numbers of symbols of a plurality of physical uplink control channel (PUCCH) resources that collide with a sounding reference signal (SRS) resource, wherein the plurality of PUCCH resources are associated with transmitting an SR; means for determining a plurality of collision values associated with the plurality of PUCCH resources; means for transmitting the SR on a PUCCH resource, of the plurality of PUCCH resources, that is associated with a collision value of the plurality of collision values; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

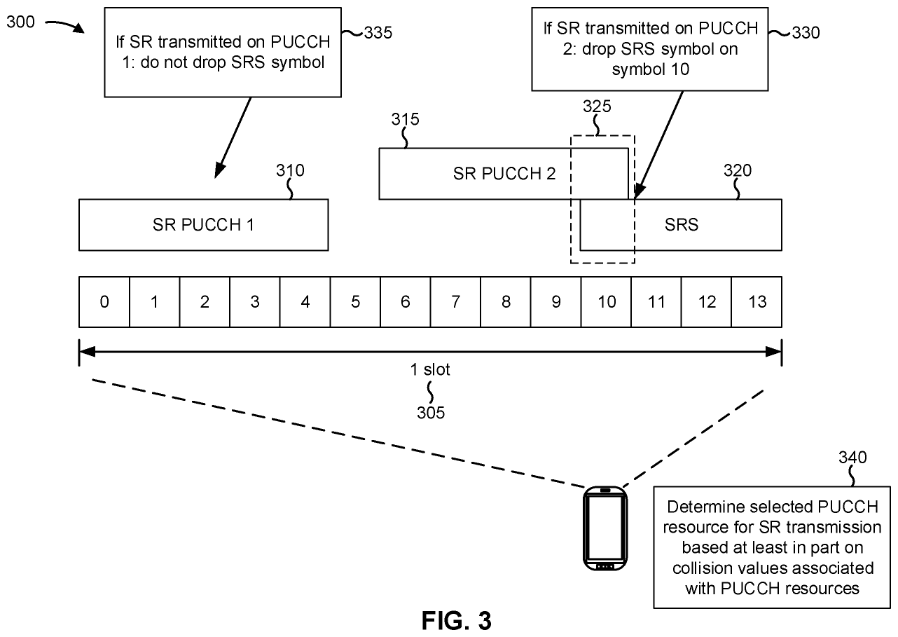

FIG. 3 is a diagram illustrating an example 300 of SR selection in consideration of a channel collision, in accordance with various aspects of the present disclosure. Example 300 shows operations performed by a UE 120 to facilitate uplink transmissions in a slot 305. As shown, the slot 305 includes 14 symbols (e.g., symbols 0 through 13). The techniques and apparatuses described herein can be performed for time intervals other than a slot (e.g., a mini-slot, a sub-slot, a group of slots, and/or the like) and for slots including more than or less than 14 symbols.

As shown by reference numbers 310 and 315, the slot 305 includes two PUCCHs that are associated with an SR. A PUCCH is a control channel used to convey uplink control information (UCI). UCI can include, for example, an SR (as shown for the PUCCHs 1 and 2 shown by reference numbers 310 and 315), hybrid automatic repeat request (HARD) feedback, channel state information, or other information. A PUCCH resource can be semi-statically configured (e.g., using radio resource control information), and the base station may configure separate PUCCH resources for different types of UCI. As shown, the slot 305 includes two PUCCH resources for an SR. For example, an SR resource (e.g., a PUCCH resource associated with an SR) can occur multiple times in a slot (e.g., every 2 symbols, every 6 symbols, every 7 symbols, and/or the like, depending on the configuration of the SR resource).

As shown by reference number 320, the slot 305 may also include a sounding reference signal (SRS) resource. An SRS is a reference signal used by a base station (e.g., BS 110) to determine a channel quality of an uplink channel. For example, the UE 120 may be configured, by the base station, to transmit SRSs to facilitate scheduling or other communication by the base station. The UE may transmit an SRS on an SRS resource. For example, the UE 120 may be configured (e.g., via system information, radio resource control information, and/or the like) with one or more SRS resources on which to transmit the SRS. Generally, the UE may be configured with one SRS resource in a slot 305, though the techniques and apparatuses described herein can be applied if the UE is configured with multiple SRS resources in a slot, as described elsewhere herein.

As shown by reference number 325, the PUCCH 2, on which the UE 120 is configured to transmit an SR, occupies a same symbol (e.g., symbol 10) as the SRS resource. A PUCCH that occupies a same symbol as an SRS resource may be referred to herein as colliding with the SRS resource. If an SR is transmitted on the PUCCH 2 on a same carrier as the SRS, then the SR and the SRS may occupy the same time/frequency resource, so the UE 120 may have to take some action to mitigate the collision of the PUCCH 2 and the SRS. For example, as shown by reference number 330, the UE 120 may drop one or more symbols of the SRS that collide with the PUCCH for the SR (here, a portion of the SRS is dropped at symbol 10, as shown by reference number 330). Such behavior (e.g., dropping one or more symbols of an SRS based at least in part on the one or more symbols of the SRS overlapping in time with a PUCCH carrying an SR) may be specified by a wireless telecommunication specification, such as Release 15 and 16 of 3GPP Technical Specification 38.214 Section 6.2.1. Dropping symbols of the SRS can affect rank selection at the base station, which negatively affects throughput, and can generally diminish the usefulness of the SRS. As shown by reference number 335, if the UE 120 transmits the SR on the PUCCH 1, which does not collide with the SRS, then the UE 120 may not drop any symbols of the SRS. Thus, if the UE 120 selects the PUCCH on which the SR is to be transmitted without consideration of whether the SR collides with an SRS, the UE may sometimes select an SR PUCCH that collides with an SRS resource, thereby diminishing the usefulness of the SRS and reducing throughput of the UE and the base station.

Techniques and apparatuses described herein provide selection of a PUCCH resource for transmission of an SR based at least in part on collision values associated with the PUCCH resources, as shown by reference number 340. For example, the UE 120 may determine a collision value for each PUCCH associated with an SR in a slot 305. The collision value may be based at least in part on a number of symbols of the PUCCH associated with the SR that collide with the SRS resource. For example, the collision value may be based at least in part on a number of symbols of the SRS resource that would be dropped if the SR were to be transmitted on a PUCCH that collides with the SRS resource. The UE 120 may select a PUCCH for transmission of an SR based at least in part on the respective collision value. For example, the UE 120 may select a PUCCH that is associated with a lowest collision value, which may be a PUCCH that causes a smallest number of symbols (or no symbols) of the SRS resource to be dropped. In this way, the UE 120 may reduce the impact of SR transmission on SRS transmission, which improves performance of sounding reference signaling, thereby improving throughput and accuracy of rank selection.

As indicated above, FIG. 3 is provided as an example. Other examples may differ from what is described with regard to FIG. 3.

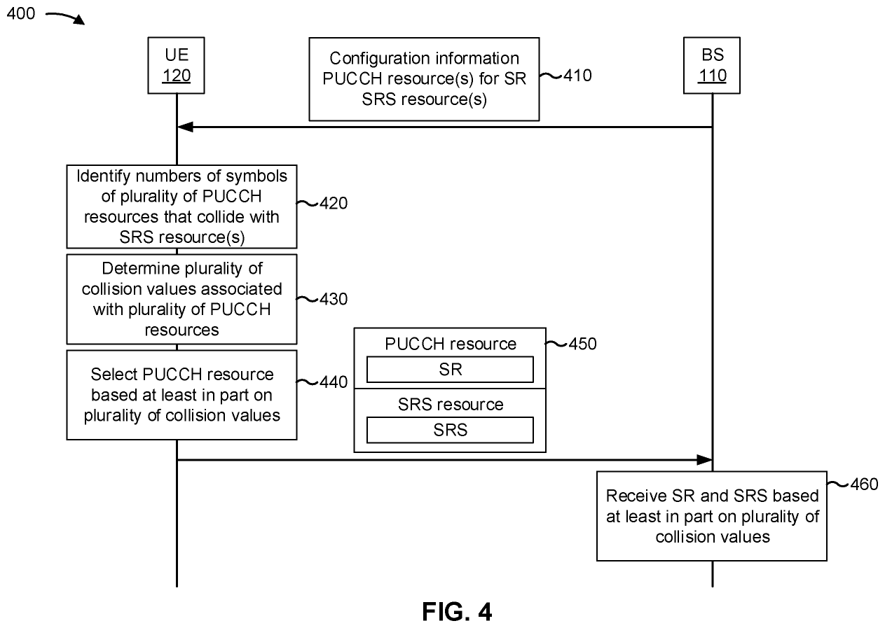

FIG. 4 is a diagram illustrating an example 400 of signaling associated with SR selection in consideration of a channel collision, in accordance with various aspects of the present disclosure. As shown, example 400 includes a UE 120 and a BS 110.

As shown by reference number 410, the BS 110 may transmit, to the UE 120, configuration information. As further shown, the configuration information may identify one or more PUCCH resources for the SR, and may identify an SRS resource. In some aspects, the configuration information may identify a plurality of SRS resources. In some cases, one or more of the PUCCH resources may collide with the SRS resource. If the UE 120 were to select a PUCCH resource that collides with the SRS resource, the UE 120 may be expected to drop one or more colliding symbols of the SRS so that the PUCCH is not impacted by the transmission of the SRS. However, the one or more dropped symbols of the SRS may negatively impact the performance of the UE 120.

As shown by reference number 420, the UE 120 may identify numbers of symbols, associated with a plurality of PUCCH resources, that collide with the one or more SRS resources. For example, if a first PUCCH resource and a second PUCCH resource are included in a slot, the UE 120 may identify a number of symbols of the first PUCCH resource that collide with an SRS resource, and may identify a number of symbols of the second PUCCH resource that collide with the SRS resource. In some aspects, the UE 120 may identify a number of symbols of a PUCCH resource that collide with any SRS resource included in a slot (e.g., if there are multiple SRS resources in a slot, the UE 120 may identify each symbol of the PUCCH resource that collides with one or more SRS resources). In some aspects, the UE 120 may determine whether one or more symbols of a PUCCH resource collide with an SRS resource. For example, the UE 120 may perform a binary determination of whether or not there is a collision between a PUCCH resource and an SRS resource. The binary determination may be less resource-intensive than a per-symbol determination, whereas the per-symbol determination may be more useful for selecting a PUCCH resource for transmission of an SR if all PUCCH resources in a slot collide with an SRS resource.

As shown by reference number 430, the UE 120 may determine a plurality of collision values associated with the plurality of PUCCH resources. A collision value may be based at least in part on a number of symbols that collide between a PUCCH resource and an SRS resource. In some aspects, the collision value may identify the number of symbols that collide. For example, referring to FIG. 3, in some aspects, the collision value for SR PUCCH 1 may be 0 (since 0 symbols of SR PUCCH 1 collide with the SRS resource 330) and the collision value for SR PUCCH 2 may be 1 (since 1 symbol of SR PUCCH 2 collides with the SRS resource 330). In some aspects, the collision value may be a binary value. For example, a first value of the collision value may indicate that no symbols collide between a PUCCH resource and an SRS resource, and a second value of the collision value may indicate that one or more symbols collide between the PUCCH resource and the SRS resource. As another example of a binary value of the collision value, a first value may indicate that fewer than a threshold number of symbols of a PUCCH resource collide with an SRS resource, and a second value may indicate that at least the threshold number of symbols of the PUCCH resource collide with the SRS resource.

As shown by reference number 440, the UE 120 may select a PUCCH resource based at least in part on the plurality of collision values. For example, the UE 120 may select a PUCCH resource for transmission of an SR. The UE 120 may select a PUCCH resource (referred to as a selected PUCCH resource) based at least in part on a collision value associated with the selected PUCCH resource. For example, the UE 120 may select a PUCCH resource, from a plurality of PUCCH resources of a slot, that is associated with a lowest collision value (e.g., a collision value that indicates a smallest number of colliding symbols, of respective numbers of colliding symbols of the plurality of PUCCH resources) of collision values corresponding to the plurality of PUCCH resources. As another example, the UE 120 may select a PUCCH resource associated with a binary value that indicates that the PUCCH resource does not collide with an SRS resource. If multiple PUCCH resources in a slot have the same collision value, the UE 120 may select the PUCCH resource based at least in part on a rule, such as a rule indicating to select an earliest PUCCH resource, a latest PUCCH resource, an earliest PUCCH resource that does not collide with an SRS resource, and/or the like. In this way, the UE 120 may select a PUCCH resource for transmission of an SR that minimizes an impact of the SR on an SRS, which improves rank selection at the BS 110 and therefore throughput of the link between the UE 120.

In some aspects, the UE 120 may select (e.g., using antenna 252, DEMOD 254, MIMO detector 256, receive processor 258, controller/processor 280, and/or the like) the PUCCH without consideration of the plurality of collision values. For example, the UE 120 may select (e.g., using antenna 252, DEMOD 254, MIMO detector 256, receive processor 258, controller/processor 280, and/or the like) an earliest PUCCH in the slot, a latest PUCCH in the slot, and/or the like. In such a case, the UE 120 may not identify collision values for the PUCCHs, which conserves processing resources and reduces latency associated with identifying the collision values.

As shown by reference number 450, the UE 120 may transmit the SR and the SRS. For example, the UE 120 may transmit the SR on the selected PUCCH, and may transmit the SRS on the SRS resource. In some aspects, if the selected PUCCH collides with one or more symbols of the SRS, the UE 120 may drop the one or more symbols of the SRS with which the selected PUCCH collides. For example, the UE 120 may drop zero or more symbols of the SRS based at least in part on whether the SRS collides with the selected PUCCH.

As shown by reference number 460, the BS 110 may receive the SR and the SRS based at least in part on the plurality of collision values. For example, in some aspects, the BS 110 may perform the operations described with regard to reference numbers 420, 430, and 440 to identify the selected PUCCH, and may receive the SR on the selected PUCCH. Additionally, or alternatively, the BS 110 may identify one or more symbols of the SRS that are dropped based at least in part on the selected PUCCH, and may receive the SRS based at least in part on the one or more symbols (e.g., may receive remaining symbols of the SRS).

As indicated above, FIG. 4 is provided as an example. Other examples may differ from what is described with regard to FIG. 4.

FIG. 5 is a diagram illustrating an example process 500 performed, for example, by a UE, in accordance with various aspects of the present disclosure. Example process 500 is an example where the UE (e.g., UE 120 and/or the like) performs operations associated with scheduling request selection in consideration of channel collision.

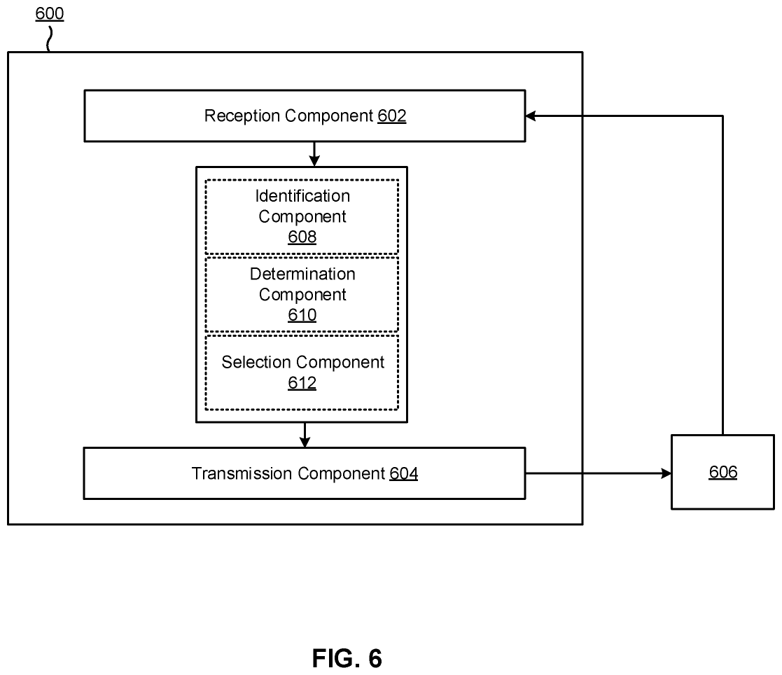

As shown in FIG. 5, in some aspects, process 500 may include identifying numbers of symbols of a plurality of PUCCH resources that collide with an SRS resource, wherein the plurality of PUCCH resources are associated with transmitting an SR (block 510). For example, the UE (e.g., using receive processor 258, transmit processor 264, controller/processor 280, memory 282, and/or the like) may identify numbers of symbols of a plurality of PUCCH resources that collide with an SRS resource, wherein the plurality of PUCCH resources are associated with transmitting an SR, as described above. In some aspects, the operation of block 510 may be performed by the identification component 608 of FIG. 6.

As further shown in FIG. 5, in some aspects, process 500 may include determining a plurality of collision values associated with the plurality of PUCCH resources (block 520). For example, the UE (e.g., using receive processor 258, transmit processor 264, controller/processor 280, memory 282, and/or the like) may determine a plurality of collision values associated with the plurality of PUCCH resources, as described above. In some aspects, the operation of block 520 may be performed by the determination component 610 of FIG. 6.

As further shown in FIG. 5, in some aspects, process 500 may include transmitting the SR on a PUCCH resource, of the plurality of PUCCH resources, that is associated with a collision value of the plurality of collision values (block 530). For example, the UE (e.g., using receive processor 258, transmit processor 264, controller/processor 280, memory 282, and/or the like) may transmit the SR on a PUCCH resource, of the plurality of PUCCH resources, that is associated with a collision value of the plurality of collision values, as described above. In some aspects, the operation of block 530 may be performed by the transmission component 604 of FIG. 6.

Process 500 may include additional aspects, such as any single aspect or any combination of aspects described below and/or in connection with one or more other processes described elsewhere herein.

In a first aspect, the collision value is a lowest collision value of the plurality of collision values.

In a second aspect, alone or in combination with the first aspect, the plurality of PUCCH resources are included in a single slot.

In a third aspect, alone or in combination with one or more of the first and second aspects, the PUCCH resource includes no symbols that collide with the SRS resource.

In a fourth aspect, alone or in combination with one or more of the first through third aspects, the PUCCH resource is associated with one or more symbols that collide with the SRS resource. The process 500 may further comprise transmitting an SRS on the SRS resource, wherein zero or more symbols of the SRS are dropped based at least in part on whether the SRS resource collides with the PUCCH resource. In some aspects, the transmission of the SRS on the SRS resource may be performed by the transmission component 604 of FIG. 6.

In a fifth aspect, alone or in combination with one or more of the first through fourth aspects, identifying the numbers of symbols of the plurality of PUCCH resources comprises determining, for each symbol of a given PUCCH resource, whether each symbol collides with any symbol of the SRS resource, and identifying the number of symbols of the given PUCCH resource that collide with the SRS resource based at least in part on whether each symbol collides with any symbol of the SRS resource, and determining the plurality of collision values comprises determining a collision value, of the plurality of respective values, for the given PUCCH resource in accordance with the number of symbols.

In a sixth aspect, alone or in combination with one or more of the first through fifth aspects, the plurality of collision values are based at least in part on a binary indicator, wherein a first value of the binary indicator indicates that no symbols of a given PUCCH resource collide with the SRS resource, and wherein a second value of the binary indicator indicates that one or more symbols of the given PUCCH resource collide with the SRS resource.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a block diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include one or more of an identification component 608, a determination component 610, or a selection component 612, among other examples.

In some aspects, the apparatus 600 may be configured to perform one or more operations described herein in connection with FIGS. 3 and 4. Additionally or alternatively, the apparatus 600 may be configured to perform one or more processes described herein, such as process 500 of FIG. 5. In some aspects, the apparatus 600 and/or one or more components shown in FIG. 6 may include one or more components of the UE described above in connection with FIG. 2. Additionally, or alternatively, one or more components shown in FIG. 6 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the UE described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the UE described above in connection with FIG. 2. In some aspects, the transmission component 604 may be collocated with the reception component 602 in a transceiver.

The identification component 608 may identify numbers of symbols of a plurality of PUCCH resources that collide with an SRS resource, wherein the plurality of PUCCH resources are associated with transmitting an SR. The identification component 608 may include antenna 252, DEMOD 254, MIMO detector 256, receive processor 258, controller/processor 280, and/or the like.

The determination component 610 may determine a plurality of collision values associated with the plurality of PUCCH resources. The determination component 610 may include DEMOD 254, MIMO detector 256, receive processor 258, controller/processor 280, and/or the like. In some aspects, the determination component 610 may determine, for each symbol of a given PUCCH resource, whether each symbol collides with any symbol of the SRS resource, and the identification component 608 may identify the number of symbols of the given PUCCH resource that collide with the SRS resource based at least in part on whether each symbol collides with any symbol of the SRS resource.

The selection component 612 may select a PUCCH based at least in part on the plurality of collision values. The selection component 612 may include DEMOD 254, MIMO detector 256, receive processor 258, controller/processor 280, and/or the like.

The transmission component 604 may transmit the SR on a PUCCH resource, of the plurality of PUCCH resources, that is associated with a collision value of the plurality of collision values.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

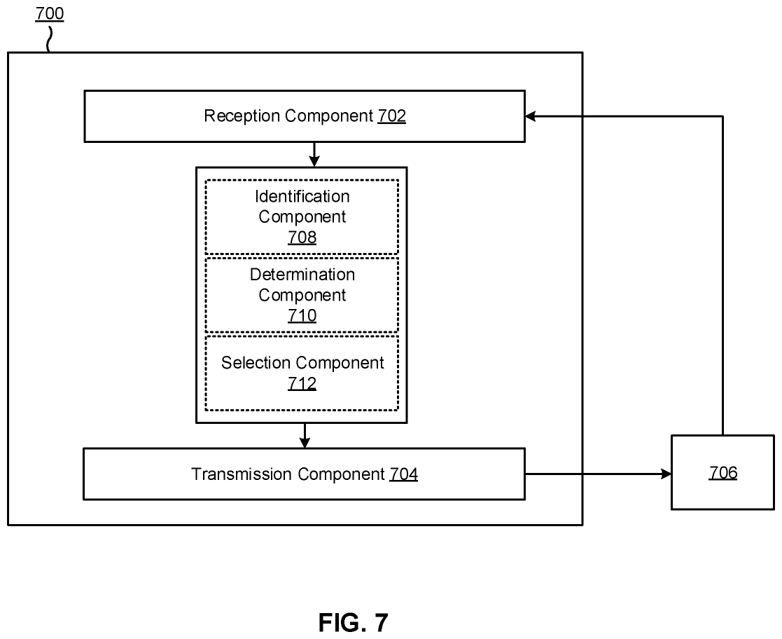

FIG. 7 is a block diagram of an example apparatus 700 for wireless communication. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 600 may include one or more of an identification component 708, a determination component 710, or a selection component 712, among other examples.

In some aspects, the apparatus 700 may be configured to perform one or more operations described herein in connection with FIGS. 3 and 4. Additionally or alternatively, the apparatus 700 may be configured to perform one or more processes described herein, such as operations described in connection with the example 400 or the process 500 of FIG. 5, or a combination thereof. In some aspects, the apparatus 700 and/or one or more components shown in FIG. 7 may include one or more components of the base station described above in connection with FIG. 2. Additionally, or alternatively, one or more components shown in FIG. 7 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the base station described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the base station described above in connection with FIG. 2. In some aspects, the transmission component 704 may be collocated with the reception component 702 in a transceiver.

The identification component 708 may identify numbers of symbols of a plurality of PUCCH resources that collide with an SRS resource, wherein the plurality of PUCCH resources are associated with transmitting an SR. The identification component 708 may include DEMOD 232, MIMO detector 236, receive processor 238, controller/processor 240, and/or the like.

The determination component 710 may determine a plurality of collision values associated with the plurality of PUCCH resources. The determination component 710 may include antenna 234, DEMOD 232, MIMO detector 236, receive processor 238, controller/processor 240, and/or the like.

The selection component 712 may select a PUCCH based at least in part on the plurality of collision values. The selection component 712 may include using antenna 234, DEMOD 232, MIMO detector 236, receive processor 238, controller/processor 240, and/or the like.

The reception component 704 may receive the SR on a PUCCH resource, of the plurality of PUCCH resources, that is associated with a collision value of the plurality of collision values.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
identifying numbers of symbols of a plurality of physical uplink control channel (PUCCH) resources that collide with a sounding reference signal (SRS) resource, wherein the plurality of PUCCH resources are associated with transmitting a scheduling request (SR);
determining a plurality of collision values associated with the plurality of PUCCH resources; and
transmitting the SR on a PUCCH resource, of the plurality of PUCCH resources, that is associated with a collision value of the plurality of collision values.

2. The method of claim 1, wherein the collision value is a lowest collision value of the plurality of collision values.

3. The method of claim 1, wherein the plurality of PUCCH resources are included in a single slot.

4. The method of claim 1, wherein the PUCCH resource includes no symbols that collide with the SRS resource.

5. The method of claim 1, wherein the PUCCH resource is associated with one or more symbols that collide with the SRS resource, and
wherein the method further comprises:
transmitting an SRS on the SRS resource, wherein zero or more symbols of the SRS are dropped based at least in part on whether the SRS resource collides with the PUCCH resource.

6. The method of claim 1, wherein identifying the numbers of symbols of the plurality of PUCCH resources comprises:
determining, for each symbol of a given PUCCH resource, whether each symbol collides with any symbol of the SRS resource; and
identifying the number of symbols of the given PUCCH resource that collide with the SRS resource based at least in part on whether each symbol collides with any symbol of the SRS resource; and
wherein determining the plurality of collision values comprises:
determining a collision value, of the plurality of respective values, for the given PUCCH resource in accordance with the number of symbols.

7. The method of claim 1, wherein the plurality of collision values are based at least in part on a binary indicator, wherein a first value of the binary indicator indicates that no symbols of a given PUCCH resource collide with the SRS resource, and wherein a second value of the binary indicator indicates that one or more symbols of the given PUCCH resource collide with the SRS resource.

8. A user equipment (UE) for wireless communication, comprising:
a memory; and
one or more processors operatively coupled to the memory, the memory and the one or more processors configured to:
identify numbers of symbols of a plurality of physical uplink control channel (PUCCH) resources that collide with a sounding reference signal (SRS) resource, wherein the plurality of PUCCH resources are associated with transmitting a scheduling request (SR);
determine a plurality of collision values associated with the plurality of PUCCH resources; and
transmit the SR on a PUCCH resource, of the plurality of PUCCH resources, that is associated with a collision value of the plurality of collision values.

9. The UE of claim 8, wherein the collision value is a lowest collision value of the plurality of collision values.

10. The UE of claim 8, wherein the plurality of PUCCH resources are included in a single slot.

11. The UE of claim 8, wherein the PUCCH resource includes no symbols that collide with the SRS resource.

12. The UE of claim 8, wherein the PUCCH resource is associated with one or more symbols that collide with the SRS resource, and
wherein the one or more processors are further configured to:
transmit an SRS on the SRS resource, wherein zero or more symbols of the SRS are dropped based at least in part on whether the SRS resource collides with the PUCCH resource.

13. The UE of claim 8, wherein the one or more processors, when identifying the numbers of symbols of the plurality of PUCCH resources, are further configured to:
determine, for each symbol of a given PUCCH resource, whether each symbol collides with any symbol of the SRS resource; and
identify the number of symbols of the given PUCCH resource that collide with the SRS resource based at least in part on whether each symbol collides with any symbol of the SRS resource; and
wherein the one or more processors, when determining the plurality of collision values, are further configured to:
determine a collision value, of the plurality of respective values, for the given PUCCH resource in accordance with the number of symbols.

14. The UE of claim 8, wherein the plurality of collision values are based at least in part on a binary indicator, wherein a first value of the binary indicator indicates that no symbols of a given PUCCH resource collide with the SRS resource, and wherein a second value of the binary indicator indicates that one or more symbols of the given PUCCH resource collide with the SRS resource.

15. A non-transitory computer-readable medium storing one or more instructions for wireless communication, the one or more instructions comprising:
one or more instructions that, when executed by one or more processors of a user equipment (UE), cause the one or more processors to:
identify numbers of symbols of a plurality of physical uplink control channel (PUCCH) resources that collide with a sounding reference signal (SRS) resource, wherein the plurality of PUCCH resources are associated with transmitting a scheduling request (SR);
determine a plurality of collision values associated with the plurality of PUCCH resources; and
transmit the SR on a PUCCH resource, of the plurality of PUCCH resources, that is associated with a collision value of the plurality of collision values.

16. The non-transitory computer-readable medium of claim 15, wherein the collision value is a lowest collision value of the plurality of collision values.

17. The non-transitory computer-readable medium of claim 15, wherein the plurality of PUCCH resources are included in a single slot.

18. The non-transitory computer-readable medium of claim 15, wherein the PUCCH resource includes no symbols that collide with the SRS resource.

19. The non-transitory computer-readable medium of claim 15, wherein the PUCCH resource is associated with one or more symbols that collide with the SRS resource, and
wherein the one or more instructions, when executed by the one or more processors, cause the one or more processors to:
transmit an SRS on the SRS resource, wherein zero or more symbols of the SRS are dropped based at least in part on whether the SRS resource collides with the PUCCH resource.

20. The non-transitory computer-readable medium of claim 15, wherein the one or more instructions, that cause the one or more processors to identify the numbers of symbols of the plurality of PUCCH resources, cause the one or more processors to:
determine, for each symbol of a given PUCCH resource, whether each symbol collides with any symbol of the SRS resource; and
identify the number of symbols of the given PUCCH resource that collide with the SRS resource based at least in part on whether each symbol collides with any symbol of the SRS resource; and
wherein the one or more instructions, that cause the one or more processors to determine the plurality of collision values, cause the one or more processors to:
determine a collision value, of the plurality of respective values, for the given PUCCH resource in accordance with the number of symbols.

21. The non-transitory computer-readable medium of claim 15, wherein the plurality of collision values are based at least in part on a binary indicator, wherein a first value of the binary indicator indicates that no symbols of a given PUCCH resource collide with the SRS resource, and wherein a second value of the binary indicator indicates that one or more symbols of the given PUCCH resource collide with the SRS resource.

22. An apparatus for wireless communication, comprising:
means for identifying numbers of symbols of a plurality of physical uplink control channel (PUCCH) resources that collide with a sounding reference signal (SRS) resource, wherein the plurality of PUCCH resources are associated with transmitting a scheduling request (SR);
means for determining a plurality of collision values associated with the plurality of PUCCH resources; and
means for transmitting the SR on a PUCCH resource, of the plurality of PUCCH resources, that is associated with a collision value of the plurality of collision values.

23. The apparatus of claim 22, wherein the collision value is a lowest collision value of the plurality of collision values.

24. The apparatus of claim 22, wherein the plurality of PUCCH resources are included in a single slot.

25. The apparatus of claim 22, wherein the PUCCH resource includes no symbols that collide with the SRS resource.

26. The apparatus of claim 22, wherein the PUCCH resource is associated with one or more symbols that collide with the SRS resource, and
wherein the apparatus further comprises:
means for transmitting an SRS on the SRS resource, wherein zero or more symbols of the SRS are dropped based at least in part on whether the SRS resource collides with the PUCCH resource.

27. The apparatus of claim 22, wherein the means for identifying the numbers of symbols of the plurality of PUCCH resources comprises:
means for determining, for each symbol of a given PUCCH resource, whether each symbol collides with any symbol of the SRS resource; and
means for identifying the number of symbols of the given PUCCH resource that collide with the SRS resource based at least in part on whether each symbol collides with any symbol of the SRS resource; and
wherein the means for determining the plurality of collision values comprises:
means for determining a collision value, of the plurality of respective values, for the given PUCCH resource in accordance with the number of symbols.

28. The apparatus of claim 22, wherein the plurality of collision values are based at least in part on a binary indicator, wherein a first value of the binary indicator indicates that no symbols of a given PUCCH resource collide with the SRS resource, and wherein a second value of the binary indicator indicates that one or more symbols of the given PUCCH resource collide with the SRS resource.
